(19) United States
(12) Patent Application Publication
(10) Pub. No.: US 2018/0009721 A1
(43) Pub. Date: Jan. 11, 2018

(54) OPERATING METHOD FOR A BATCH PROCESS

(71) Applicant: AnaeCo Limited, Bentley, Western Australia (AU)

(72) Inventors: Lee Richard WALKER, High Wycombe, Western Austalia (AU); Gareth James BUCKLAND, Rockingham, Western Australia (AU); Sean Neil SCIBERRAS, Sorrento, Western Australia (AU); Kim SPUNNER, Salter Point, Western Australia (AU)

(73) Assignee: AnaeCo Limited, Bentley, Western Australia (AU)

(21) Appl. No.: 15/536,819

(22) PCT Filed: Dec. 11, 2015
(86) PCT No.: PCT/AU2015/000750

§ 371 Date: Jun. 16, 2017

(30) Foreign Application Priority Data
Dec. 16, 2014 (AU) 2014905087

(51) Int. Cl. C05F 17/00; C02F 11/04; C02F 3/30; C05F 7/00; B09B 3/00

(52) U.S. Cl. CPC C05F 17/0027; C05F 7/00; B09B 3/00; C02F 3/301; C02F 11/04

(57) ABSTRACT

An operating method for a batch process, the batch process comprising a plurality of operating phases and within each phase there is provided at least one operating mode, one of the modes of each phase being a standby mode or its equivalent, wherein a transition from a first phase to a second phase requires that the first phase be initialised to its standby mode or equivalent and upon completion of the phase change the second phase enters its standby mode or equivalent.

### FIELD OF THE INVENTION

The present invention relates to an operating method for a batch process. More particularly, the batch process of the present invention is directed to the treatment of the organic fraction of mixed municipal solid waste (“OFMSW”).

The batch process of the present invention has particular application in the treatment of the organic fraction of mixed municipal solid waste (“OFMSW”) when that process includes alternating phases of aerobic and anaerobic treatment. Further, particular advantages are realised when these processes are conducted in a single reactor vessel.

### BACKGROUND ART

The treatment of mixed municipal solid waste (“MSW”) presently most typically comprises passing that waste to some form of separation process by which organic materials therein are first separated, as much as possible, from inorganic materials. This initial separation step is invariably a size based separation, with organic material typically being smaller or softer than much of the inorganic material. The organic materials are subsequently directed, at least in part, to a biological stabilisation or degradation process, whilst the inorganic material is sorted into recyclables and non-recyclables, the latter being passed to landfill. The product of the biological stabilisation or degradation process is ideally a compost material and/or a biogas.

Typically, systems for the biodegradation of organic waste material are directed to either aerobic or anaerobic processes. However, there are a small number of systems that have sought to combine both anaerobic and aerobic biodegradation processes. The processes of German Patent 4440750 and International Patent Application PCT/DE1994/000440 (WO 1994/024071) each describe the combination of an anaerobic fermentation unit and an aerobic composting unit. Importantly, these systems describe discrete and separate vessels for the aerobic and anaerobic biodegradation processes.

It is known that solid organic waste material may be treated under either anaerobic or aerobic conditions to produce a bioactive, stable end product that, for example, may be used as compost for gardens. This process is achieved through the action of, respectively, anaerobic or aerobic microorganisms that are able to metabolise the organic waste material to produce the bioactive, stable end product.

It is also known that the aerobic decomposition of solid organic waste material takes place in the presence of oxygen. The temperature of the waste material rises as some of the energy produced during aerobic decomposition is released as heat, often reaching temperatures of approximately 75° C. under ambient conditions. The solid end product is often rich in nitrates which are a readily bio-available source of nitrogen for plants, making the end product particularly suitable as a fertiliser.

It is further known that the anaerobic digestion of solid organic waste material takes place in the absence of oxygen. Anaerobic microbial metabolism is understood to be optimised when the organic material is heated to temperatures at which mesophilic or thermophilic bacteria are operative. The process of anaerobic microbial metabolism results in the production of biogas, in turn predominantly methane and carbon dioxide. The solid product of the process is often rich in ammonium salts. Such ammonium salts are not readily bio-available and are, consequently, generally treated under conditions in which aerobic decomposition will occur. In this manner the material is used to produce a product that is bio-available.

International Patent Application PCT/AU00/00865 (WO 01/05729), filed by the current Applicant's predecessor in title, describes an improved process and apparatus in which aerobic and anaerobic processes are combined for the treatment of the organic fraction of MSW (OFMSW), and in which many of the inefficiencies of the previous processes and apparatus are overcome. The process and apparatus are characterised at a fundamental level by the sequential treatment of organic waste material in a single vessel, through an initial aerobic step to raise the temperature of the organic waste material, an anaerobic digestion step and a subsequent aerobic treatment step. During the anaerobic digestion step a process water or inoculum containing microorganisms is introduced to the vessel to create conditions suitable for efficient anaerobic digestion of the contents and the production of biogas. The introduced inoculum also aids in heat and mass transfer as well as providing buffer capacity to protect against acidification. Subsequently, air is introduced to the residues in the vessel to create conditions for aerobic degradation. It is further described that the water introduced during anaerobic digestion may be sourced from an interconnected vessel that has undergone anaerobic digestion.

The sequential treatment of organic waste material in a single vessel requires that the process be conducted as a batch process. Whilst the single vessel process described in PCT/AU00/00865 (WO 01/05729) provides many advantages with respect to prior art processes, it does create challenges in transitioning between the aerobic and anaerobic stages of treatment, and in turn from that anaerobic stage back to an aerobic stage of treatment. The process of International Patent Application PCT/AU00/00865 (WO 01/05729) describes the manipulation of the environmental conditions to which the OFMSW is exposed to facilitate the degradation by a variety of microorganisms.

The microorganisms employed during anaerobic digestion of the biomass typically comprise a delicate balance of “acid producing” and “acid consuming” micro-organisms. For example, in an uninoculated system the number of acid producing micro-organisms typically exceed the number of acid consuming micro-organisms.

The consortium of bacterial species which lead to the production of organic acids will typically cause the pH of a decomposing biomass to drop (become more acidic). Acid consuming microbial species contribute to the production of biogas, including methane, and cause the pH to rise (become more alkaline or basic). Early in a typically batch anaerobic digestion, the number of organic acid producing bacteria exceed those that consume these acids. This imbalance can result in acidification, process instability and/or process failure and highlights the need for accurate monitoring of the process.

Similarly, the introduction of microorganisms to the reactor is not something that can readily be monitored when the process is being conducted on a commercial scale and in real time. In the process of International Patent Application PCT/AU00/00865 (WO 01/05729) the liquid produced during the anaerobic phase of decomposition is re-used. As such, the process is re-exposed to what has been produced in that earlier anaerobic phase and is present in the liquid that has been re-used. Consequently, the conditions in the reactor may become too acidic over time. This is particularly the case if the level of volatile fatty acids (VFAs) is rising due to incomplete microbial exhaustion of the VFA present in the liquid from a previous batch prior to reintroduction to the reactor. The postulated decrease in pH may eventually lead to process failure.

Similarly, temperature maintenance of static high solids batch anaerobic digestion processes becomes difficult due to poor mixing and inefficient mass and energy transfer. The ensuing unfavourable conditions may also provide poor microbial performance, such as a decrease in the metabolism of the microorganisms as a result of lower temperature. In turn, the performance of the degradation process and the production of biogas are hampered.

The process and apparatus of Application PCT/AU00/00865 (WO 01/05729), in which aerobic and anaerobic processes are combined for the treatment of OFMSW, are further described in several further International Patent Applications, including Applications PCT/AU2012/000738 (WO 2013/003883), PCT/2012/001057 (WO 2013/033772) and PCT/AU2012/001058 (WO 2013/033773), for example. These POT applications describe different aspects of the process and/or apparatus first described, in a relatively fundamental and formative form, in Application PCT/AU00/00865 (WO 01/05729), and the content of each is expressly incorporated herein by reference.

As noted hereinabove, the prior art has largely been directed to either aerobic or anaerobic processes, not to methods in which both aerobic and anaerobic processes take place. Nor have the prior art methods typically described both aerobic and anaerobic processes taking place in the one reactor. With both processes taking place in the one reactor it presents the challenge of how to effectively transition between the aerobic and anaerobic stages of treatment as these transitions require that a number of variables are managed effectively.

The operating method for a batch process of the present invention has as one object thereof to overcome substantially the abovementioned problems of the prior art, or to provide a useful alternative thereto.

The preceding discussion of the background art is intended to facilitate an understanding of the present invention only. The discussion is not an acknowledgement or admission that any of the material referred to is or was part of the common general knowledge as at the priority date of the application.

Throughout the specification and claims, unless the context requires otherwise, the word “comprise” or variations such as “comprises” or “comprising”, will be understood to imply the inclusion of a stated integer or group of integers but not the exclusion of any other integer or group of integers.

Throughout the specification and claims, unless the context requires otherwise, the term “body of organic material”, variations thereof, or the term Organic Fraction of Municipal Solid Waste (OFMSW), will be understood to imply an organic mass, body or component, composed of man-made or natural organic material. Such may include food, kitchen, animal, garden, vegetable or other putrescible material suitable for anaerobic and aerobic action, the by-products of which are at least a gas, more specifically a biogas, and a composted, carbon reduced end product, water and inoculum. The biogas may comprise at least hydrocarbons such as methane and ethane, carbon dioxide, hydrogen, nitrogen, oxygen, and sulphurous gases such as hydrogen sulphide in any ratio.

Throughout the specification and claims, unless the context requires otherwise, the term Safety Instrumented System and the acronym SIS, or variations thereof, will be understood to include reference to any engineered set of hardware and/or software controls, such as are utilised on critical process systems, and which are engineered to maintain safe operation of a process. Such systems are generally independent of any or all of any other control systems that may be in place to control the same equipment, whereby the functionality of the system is not compromised.

Throughout the specification and claims, unless the context requires otherwise, the term Basic Process Control System or BPCS is to be understood to include reference to any control system of a dynamic system or process in which the elements of the control system are not centrally located, but are rather distributed throughout the system or process.

Throughout the specification and claims, unless the context requires otherwise, the term standby mode is to be understood as a target configuration of valves and drives that define a known idle and safe state from which all operational modes or changes of phase can occur.

### DISCLOSURE OF THE INVENTION

In accordance with the present invention there is provided an operating method for a batch process, the batch process comprising a plurality of operating phases and within each phase there is provided at least one operating mode, one of the modes of each phase being a standby mode or its equivalent, wherein a change from a first phase to a second phase requires that the first phase be initialised to its standby mode or equivalent and upon completion of the phase change the second phase enters its standby mode or equivalent.

Preferably, the valve and drive configurations of the standby modes in phases between which a transition may occur are substantially similar, thereby allowing efficient progression from one phase to another.

The equivalent of the or each standby mode is preferably a target configuration of valves and drives imbedded within a distinct mode or within a sequence of modes or phases involved in a change from the first stage to the second stage.

In one embodiment of the present invention the batch process is directed to the treatment of the organic fraction of mixed municipal solid waste (“OFMSW”).

Preferably, the process for the treatment of the organic fraction of mixed municipal solid waste includes alternating phases of aerobic and anaerobic treatment.

Still preferably, the alternating phases of aerobic and anaerobic treatment are conducted in a single reactor vessel.

In one form of the present invention wherein the batch process is directed to the treatment of the organic fraction of mixed municipal solid waste, the operating phases comprise the following phases:
(i) Aerobic;
(ii) Anaerobic; and
(iii) Transition.

Preferably, the Transition operating phase in turn comprises one or other of an Aerobic-to-Anaerobic-Transition phase, to remove oxygen from the vessel/reactor headspace, and an Anaerobic-to-Aerobic-Transition phase, to remove methane from, and introduce oxygen into, the vessel/reactor headspace whilst avoiding the formation of a flammable gas mixture.

Preferably, the Aerobic phase comprises one or more of the following modes of operation:
(i) Standby
(ii) Loading (draft)
(iii) Loading & recirculate solids (draft)
(iv) Recirculate solids (draft)
(v) Unloading (draft)
(vi) Recirculate solids (pressure vent)
(vii) Pressure vent

Preferably, the Aerobic-to-Anaerobic-Transition phase comprises the following modes of operation:
(i) Standby
(ii) Transition

Preferably, the Anaerobic phase comprises the following modes of operation:
(i) Standby
(ii) Fill & recirculate liquid
(iii) Empty liquid
(iv) Recirculate solids

In one form of the present invention the Anaerobic-to-Aerobic-Transition phase comprises the following modes of operation:
(i) Standby
(ii) Pressure vent
(iii) Purge

The purge of step (iii) of the Anaerobic-to-Aerobic Transition phase may, in one form, be a purge to an odour management system (OMS).

In a further form of the present invention the pressure vent mode of operation (ii) may be replaced by a continuous purge of an inert or exhaust gas.

In one form of the present invention there is further provided a safety instrumented system.

Preferably, there is further provided a basic process control system that operates in accordance with, and is governed by, the safety instrumented system.

Preferably, the SIS makes decisions regarding the granting of permission when it is requested by the BPCS based on a number of parameters at that time, including one or more of valve positions/settings, pressure, gas composition and flow rates.

The BPCS is preferably set at a ‘lower’ or ‘earlier’ level thereby substantially avoiding circumstances in which the SIS needs to intervene and halt the process, and which would cause a failsafe state.

Preferably, to initialise a change of phase, the following steps are undertaken:
(i) The mode for a current phase is set to a phase specific standby mode;
(ii) The SIS confirms that it is safe to make the change of phase;
(iii) The BPCS moves specific BPCS controlled valves to appropriate positions in preparation for the change of phase;
(iv) The BPCS requests the SIS to make the change of phase;
(v) The SIS moves SIS controlled valves to the appropriate valve states;
(vi) The SIS sets its phase to the new phase;
(vii) The SIS informs the BPCS of the new phase and monitors the BPCS movement to the new phase;
(viii) The BPCS sets the phase to the new phase;
(ix) The BPCS moves BPCS controlled valves into position to facilitate the change of phase to appropriate phase specific standby state; and
(x) The BPCS mode is set to standby and provides confirmation to the SIS.

The BPCS and SIS perform a ‘handshake’ at steps (ii) and (iv), whereby the BPCS requests the permission of the SIS to make the phase change.

With regard to step (vii), if the BPCS is not set to the new phase within a specific time frame from the commencement of step (iii), the SIS preferably reverts to the previous phase and will raise a phase change failure alarm.

Preferably; the specific time frame is a period of about 2 minutes.

Still preferably, only the following phase changes are possible:
(i) Aerobic phase to Aerobic-to-Anaerobic Transition phase;
(ii) Aerobic-to-Anaerobic-Transition phase can change, depending upon process conditions, to either of Aerobic phase or Anaerobic phase;
(iii) Anaerobic phase to Anaerobic-to-Aerobic-Transition phase; and
(iv) Anaerobic-to-Aerobic-Transition phase can change, depending upon process conditions, to either of Aerobic phase or Anaerobic phase.

In accordance with the present invention there is further provided a method for operating a batch process, the batch process being a process for the treatment of the organic fraction of mixed municipal solid waste comprising alternating phases of aerobic and anaerobic treatment, the alternating phases of aerobic and anaerobic treatment being conducted in a single reactor vessel, wherein within each phase there is provided at least one operating mode, one of the modes of each phase being a standby mode or its equivalent, wherein a change from a first phase to a second phase requires that the first phase be initialised to its standby mode or equivalent and upon completion of the phase change the second phase enters its standby mode or equivalent.

### BRIEF DESCRIPTION OF THE DRAWINGS

The present invention will now be described, by way of example only, with reference to one embodiment thereof and the accompanying drawings, in which:

FIGS. 1(a) and 1(b) are to be read in conjunction and provide a diagrammatic representation of the several phases of the batch process for the treatment of organic waste material to which the method of the present invention is applied in accordance with one embodiment thereof, showing the several modes within each phase and the sequences in which the modes and phases may change;

FIG. 2 is a Table of desired Standby valve positions in each of the several phases of the batch process for the treatment of organic waste material to which the method of the present invention is applied, as shown in FIGS. 1(a) and 1(b);

FIGS. 3(a) and 3(b) are to be read in conjunction and provide a flowchart representing the integration of the SIS and BPCS of the batch process for the treatment of organic waste material to which the method of the present invention is applied, as shown in FIGS. 1(a) and 1(b); and

FIG. 4 is a diagrammatic/schematic representation of a Fail to Closed SIS controlled valve and its associated valve control function block.

### BEST MODE(S) FOR CARRYING OUT THE INVENTION

As noted hereinabove, International Patent Application PCT/AU00/00865 (WO 01/05729) describes an improved process and apparatus in which aerobic and anaerobic processes are combined for the treatment of the organic fraction of MSW (OFMSW). The process and apparatus are characterised at a fundamental level by the sequential treatment of organic waste material in a single vessel or reactor, through an initial aerobic step to raise the temperature of the organic waste material, and a subsequent anaerobic digestion step. During the anaerobic digestion step a process water or inoculum containing microorganisms is introduced to the vessel to create conditions suitable for efficient anaerobic digestion of the contents and the production of biogas. The introduced inoculum also aids in heat and mass transfer as well as providing buffer capacity to protect against acidification. Subsequently, air is introduced to the residues in the vessel to create conditions for aerobic degradation. The entire content of International Patent Application PCT/AU00/00865 (WO 01/05729) is specifically incorporated herein by reference.

It is further described in PCT/AU00/00865 (WO 01/05729) that the water introduced during anaerobic digestion may be sourced from an interconnected vessel that has undergone anaerobic digestion.

The sequential treatment of organic waste material in a single vessel requires that the process be conducted as a batch process, albeit that multiple vessels may be utilised. In such an arrangement each vessel still houses the sequential treatment of organic waste material in a single vessel, through an initial aerobic step to raise the temperature of the organic waste material, and a subsequent anaerobic digestion step.

The single vessel process described in PCT/AU00/00865 (WO 01/05729) presents challenges in transitioning between the aerobic and anaerobic stages of treatment, and in turn from that anaerobic stage back to an aerobic stage of treatment.

The present invention provides a method of operating a batch process, such as the organic waste material treatment process described in PCT/AU00/00865 (WO 01/05729). The present invention will now be described with particular reference to the organic waste material treatment process and plant (hereinafter “the process” and “the plant”, respectively) as described in PCT/AU00/00865 (WO 01/05729) and for which additional aspects thereof are described in the Applicant's International Patent Applications PCT/AU2012/000738 (WO 2013/003883), PCT/2012/001057 (WO 2013/033772), PCT/AU2012/001058 (WO 2013/033773) and PCT/AU2012/000739 (WO 2013/003884).

In the process the environmental conditions to which the organic waste material, such as an OFMSW, is exposed are manipulated to facilitate the degradation thereof by a variety of microorganisms. These environmental conditions have been categorised by the Applicants as a number of, or series of, operating phases as follows:
(i) Aerobic;
(ii) Anaerobic; and
(iii) Transition.

The Transition operating phase in turn comprises one or other of an Aerobic-to-Anaerobic-Transition phase, to remove oxygen from the vessel/reactor headspace, and an Anaerobic-to-Aerobic-Transition phase, to remove methane from, and introduce oxygen into, the vessel/reactor headspace whilst avoiding the formation of a flammable gas mixture.

Within each of the phases there are provided a number of operating activities, or modes. The modes of operation provided within each phase are set out, by way of example, in Table 1 below:

TABLE 1

| Phase | Modes within Phase |
|---|---|
| Aerobic | Standby |
| | Loading (draft) |
| | Loading & recirculate solids (draft) |
| | Recirculate solids (draft) |
| | Unloading (draft) |
| | Recirculate solids (pressure vent) |
| | Pressure vent |
| Aerobic-to-Anaerobic-Transition | Standby |
| | Transition |
| Anaerobic | Standby |
| | Fill & recirculate liquid |
| | Empty liquid |
| | Recirculate solids |
| Anaerobic-to-Aerobic-Transition | Standby |
| | Pressure vent |
| | Purge, for example to OMS |

Each phase has provided therein a standby mode, or its equivalent, which places the plant or process in a defined idle state. Each phase is further defined by a set of valve configurations and motor states that are used to achieve the idle state. To change between two modes of operation within a specific phase the phase specific standby mode, or its equivalent, is entered before entering the required mode of operation. In case of fault or failure in the plant or process, the SIS/BPCS moves the process to the idle state.

The standby modes of the plant are states in which the plant may remain operable, in that the waste treatment process remains on-going, albeit in what may be termed a ‘parked’ state, or an ‘on-hold’ state.

It is envisaged that a number of the modes of operation noted above may be incorporated into one or more ‘consolidated sequences’ without departing from the spirit and scope of the present invention. Such a consolidated sequence is a predetermined combination of modes of operation.

It is further envisaged that the equivalent of the or each standby mode comprises a target configuration of valves and drives imbedded within a distinct mode or within a sequence of modes involved in a change from the first stage to the second stage.

In addition to the above, the method of the present invention comprises, as does the plant, both a Safety Instrumented System (SIS) and a Basic Process Control System (BPCS). The SIS sits above, or across the top of, the BPCS, thereby ‘governing’ the BPCS.

To initialise a change of phase the following steps are undertaken:
(i) The mode for the current phase is set to the phase specific standby mode;
(ii) The SIS confirms that it is safe to make the change of phase;
(iii) The BPCS moves specific BPCS controlled valves to the appropriate positions in preparation for the change of phase;
(iv) The BPCS requests the SIS to make the change of phase;
(v) The SIS moves SIS controlled valves to the appropriate valve states;
(vi) The SIS sets its phase to the new phase;
(vii) The SIS informs the BPCS of the new phase and monitors the BPCS movement to the new phase;
(viii) The BPCS sets the phase to the new phase;
(ix) The BPCS moves BPCS controlled valves into position to facilitate the change of phase to appropriate phase specific standby state; and
(x) The BPCS mode is set to standby and provides confirmation to the SIS.

As can be noted from the above, the BPCS and SIS perform a ‘handshake’ at steps (ii) and (iv). In effect, the BPCS is requesting the permission of the SIS to make the phase change. This is referred to as a ‘permissive’ at various points in the specification.

With regard to step (vii) above, if the BPCS is not set to the new phase within a specific time frame, for example two minutes, from the commencement of step (iii), the SIS will revert to the previous phase and will raise a phase change failure alarm.

In general terms, the SIS makes decisions regarding the granting of permission when it is requested by the BPCS based on a number of parameters within the plant at that time, including but not necessarily limited to valve positions/settings, pressure, gas composition and flow rates. Importantly, the BPCS is set at a ‘lower or’ earlier level in an effort to avoid circumstances in which the SIS may need to intervene and halt the process, causing a failsafe state, to be defined hereinafter. The failsafe state is very similar to the standby states defined herein.

Only the following phase changes are possible under the method of the present invention:
(i) Aerobic phase to Aerobic-to-Anaerobic Transition phase;
(ii) Aerobic-to-Anaerobic-Transition phase can change, depending upon process conditions, to either of Aerobic phase or Anaerobic phase;
(iii) Anaerobic phase to Anaerobic-to-Aerobic-Transition phase; and
(iv) Anaerobic-to-Aerobic-Transition phase can change, depending upon process conditions, to either of Aerobic phase or Anaerobic phase.

The method of operating a batch process of the present invention will now be described, and may be better understood, with reference to the following non-limiting example.

### Example

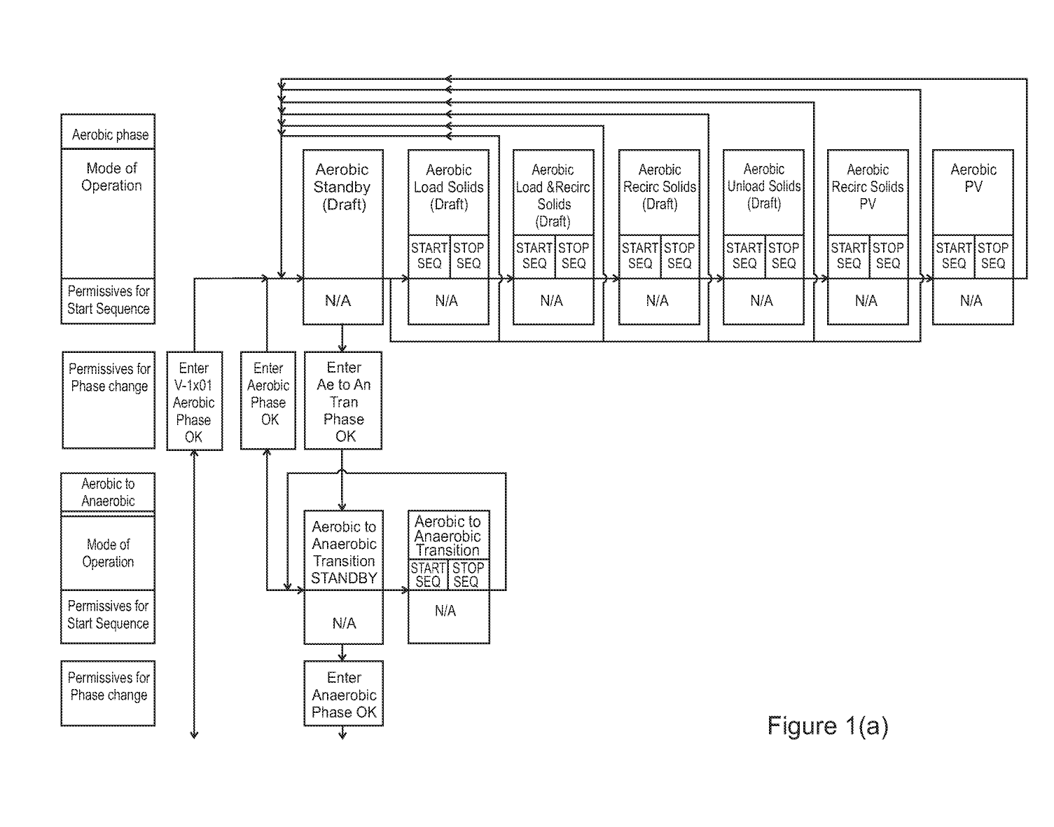

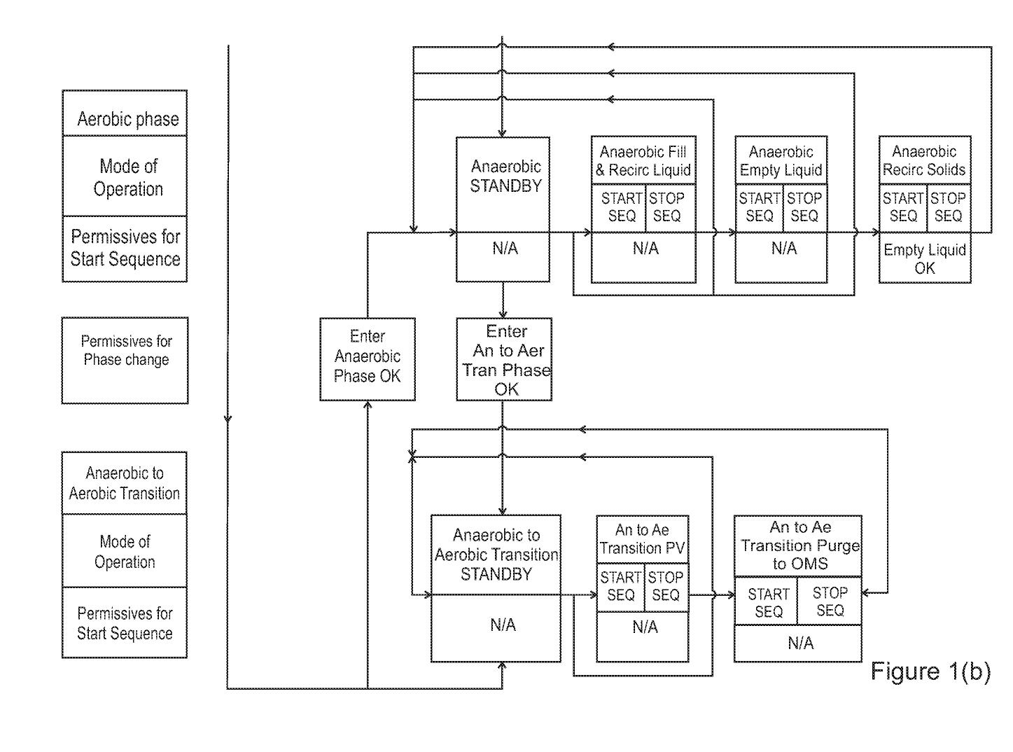

This Example describes the functional requirements in relation to integration of the SIS and BPCS for the purposes of vessel mode/phase change. The Example can be read in conjunction with FIGS. 1(a) and 1(b) which show each of the phases of the batch process, and each of the modes within each phase.

Each vessel has a group of valves to control gases flowing in and out of the vessel headspace. These valves control purge gas (air/nitrogen) entering the vessel and biogas (approx. 50% CH₄), transitional gas (0.1-50% CH₄) and odorous gas (<1% CH₄) exiting the vessel. There are two valves per line, one controlled by the BPCS and one controlled by the SIS.

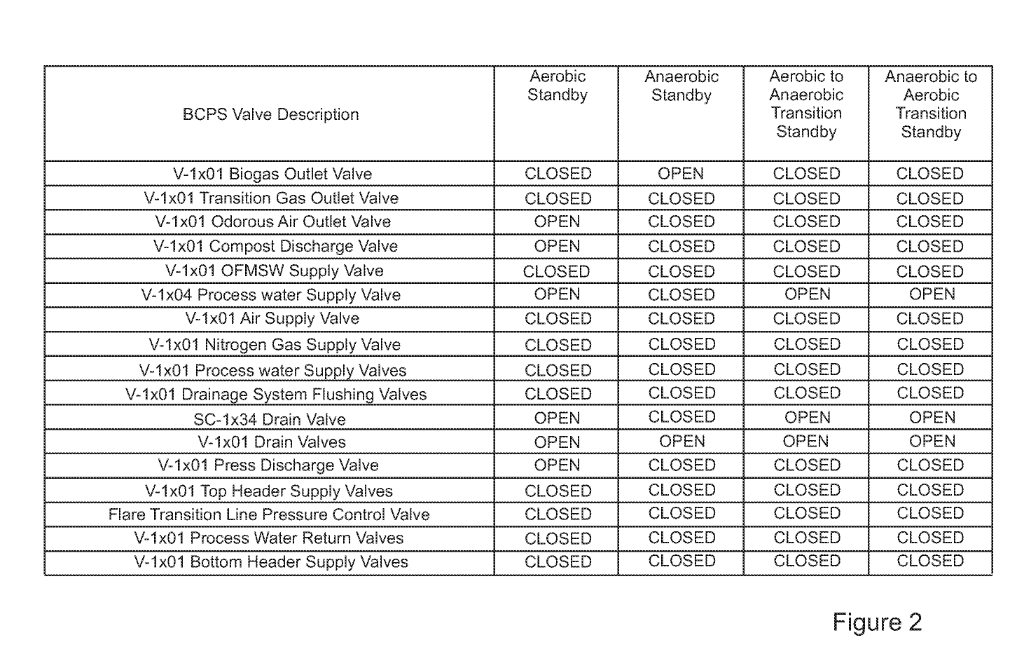

As described above, there are four defined phases for each vessel (“Aerobic”, “Aerobic-to-Anaerobic-Transition”, “Anaerobic” and “Anaerobic-to-Aerobic-Transition”) which require the SIS (and BPCS) valves to be in certain positions to maintain a safe state during normal operation. The BPCS valve positions required for normal operation in each phase are as shown in the table of FIG. 2. The SIS valve positions required for normal operation in each phase are as shown in Table 2 below.

TABLE 2

| | | Aerobic-to- | | Anaerobic-to- |
|---|---|---|---|---|
| | | Anaerobic- | | Aerobic- |
| SIS Valve | Aerobic | Transition | Anaerobic | Transition |
| Description | Phase | Phase | Phase | Phase |
| Biogas | CLOSED | CLOSED | OPEN | CLOSED |
| Supply Valve | | | | |
| Transition Line | CLOSED | OPEN | CLOSED | OPEN |
| Supply Valve | | | | |
| OMS Supply | OPEN | CLOSED | CLOSED | CLOSED |
| Valve | | | | |
| Air Blower | OPEN | CLOSED | CLOSED | OPEN |
| Supply Valve | | | | |
| OMS Bypass | CLOSED | OPEN | CLOSED | OPEN |
| Valve | | | | |
| Nitrogen | OPEN | OPEN | OPEN | OPEN |
| Supply Valve | | | | |

The following conditions trip the SIS valves to the CLOSED position to create a failsafe state. In each case the BPCS will act, at a lower value, on the corresponding BPCS controlled valves to initiate a BPCS equivalent failsafe state.

Transition Line Supply Valve:
Anaerobic-to-Aerobic-Transition:
   If the methane concentration is greater than the lower explosive limit (LEL) for methane in air less a safety margin, for example 3%.
Anaerobic-to-Aerobic-Transition:
   If the methane concentration is greater than the LEL for methane in air, for example 4%, and the oxygen concentration is greater than the minimum oxygen concentration (MOO) for methane less a safety margin, for example 5%; or
   If the oxygen concentration is less than the MOO for methane, for example 11%, but greater than a safety margin, for example 5%, and the methane concentration is greater than the LEL for methane in air less a safety margin, for example 3 to 4%; or
   If the oxygen concentration is greater than the MOO for methane, for example 11%, and methane is greater than the LEL for methane in air less a safety margin, for example 3%.

OMS Supply Valve:
If the Odour Management System (OMS) is Off; or
If the methane concentration is greater than the Lower Explosive Limit (LEL) for methane in air less a safety margin, for example 1%; or
Vessel Pressure is nearing the vessel under-pressure relief valve relieving pressure, for example between about −5 kPa to −0.4 kPa.

Air Blower Supply Valve:
Aerobic Phase:
   Vessel Pressure is nearing the vessel relief valve relieving pressure, for example between about 30 kPa and 1000 kPa,
Anaerobic-to-Aerobic-Transition:
   Vessel Pressure is nearing the vessel relief valve relieving pressure, for example between about 20 kPa to 1000 kPa; or
   If the methane concentration is greater than the LEL for methane in air, for example 4%, and the oxygen concentration is greater than the MOO for methane less a safety margin, for example 5%; or
   If the oxygen concentration is less than the MOO for methane, for example 11%, but greater than a safety margin, for example 5%, and the methane concentration is greater than the LEL for methane in air less a safety margin, for example 3 to 4%; or
   If the oxygen concentration is greater than the MOO for methane, for example 11%, and methane is greater than the LEL for methane in air less a safety margin, for example 3%.

OMS Bypass Valve:
Aerobic-to-Anaerobic-Transition and Anaerobic-to-Aerobic-Transition Phases:
   Vessel Pressure is nearing the vessel under-pressure relief valve relieving pressure, for example between about −5 kPa to −0.4 kPa; or
   If the methane concentration is greater than the LEL for methane in air less a safety margin, for example 2%; or
   If the OMS is off.

Nitrogen Supply Valve:
Aerobic and Anaerobic:
   Vessel Pressure is nearing the vessel relief valve relieving pressure, for example between about 30 kPa and 1000 kPa.
Aerobic-to-Anaerobic-Transition and Anaerobic-to-Aerobic-Transition Phases:
   Vessel Pressure is nearing the vessel relief valve relieving pressure, for example between about 20 kPa to 1000 kPa.

In addition, the SIS valves may be required to change position in the event of a Safety Instrumented Function (SIF) being activated, so as to bring the process back to a safe state. The valve positions during activation of process SIFs take precedence over those defined for normal operation, such as described and set out in Table 2 above.

Each vessel has 16 modes of operation, these modes being defined and controlled in the BPCS. The SIS sets the phase of the vessel and the BPCS then aligns with the assigned phase. The modes and phases are listed in Table 3 below and accord with those set out hereinabove at Table 1.

TABLE 3

| Vessel Mode (BPCS) | Vessel Phase (SIS) |
|---|---|
| Aerobic Standby (Draft) | Aerobic Phase |
| Aerobic Loading (Draft) | Aerobic Phase |
| Aerobic Loading and Recirc Solids | Aerobic Phase |
| (Draft) | |
| Aerobic Recirc Solids (Draft) | Aerobic Phase |
| Aerobic Unloading (Draft) | Aerobic Phase |
| Aerobic Recirc Solids (Pressure Vent) | Aerobic Phase |
| Aerobic Pressure Vent | Aerobic Phase |
| Aerobic-to-Anaerobic-Transition | Aerobic-to-Anaerobic-Transition |
| Standby | Phase |
| Aerobic-to-Anaerobic-Transition | Aerobic-to-Anaerobic-Transition |
| | Phase |
| Anaerobic Standby | Anaerobic Phase |
| Anaerobic Fill & Recirc liquid | Anaerobic Phase |
| Anaerobic Empty liquid | Anaerobic Phase |
| Anaerobic Recirc Solids | Anaerobic Phase |
| Anaerobic-to-Aerobic-Transition | Anaerobic-to-Aerobic-Transition |
| Standby | Phase |
| Anaerobic-to-Aerobic-Transition | Anaerobic-to-Aerobic-Transition |
| Pressure Vent | Phase |
| Anaerobic-to-Aerobic-Transition | Anaerobic-to-Aerobic-Transition |
| Purge, for example to OMS | Phase |

An operator is able to initiate a mode change (subject to their operating schedule and mode change permissives). Each mode change is realised through completion of a BPCS mode change sequence. To initiate a change of mode, away from the phase specific Standby mode, a BPCS START sequence is run and to return to the phase specific Standby mode a BPCS STOP sequence is run.

Phase changes require a controlled change of SIS (and BPCS) valve positions during normal operation of the plant. This will be required when changing between any of the “Standby” modes, for example when changing from Aerobic Standby (Draft) to Aerobic-to-Anaerobic-Transition Standby.

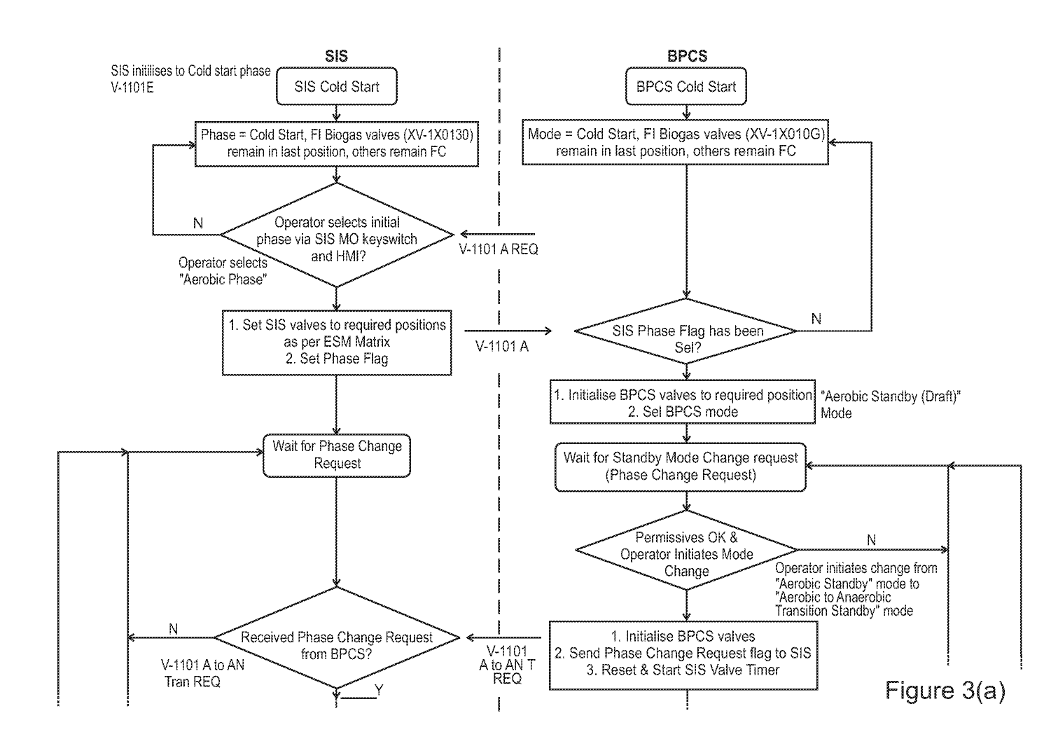

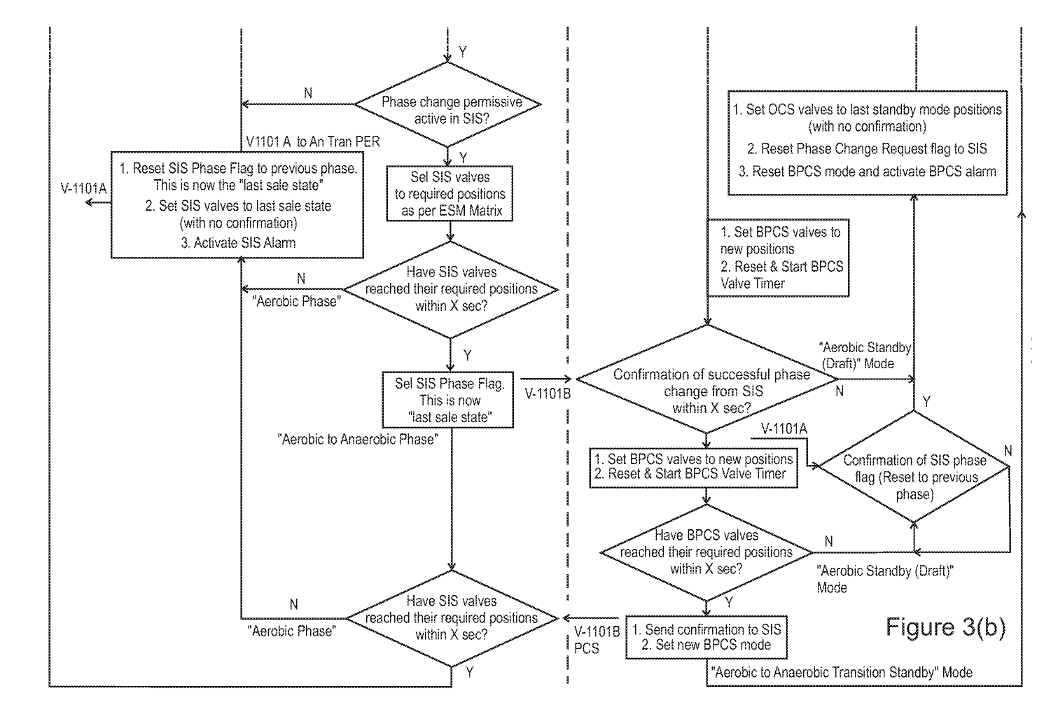

The steps required when changing between Standby modes can be summarised below, with this example relating to the change between Aerobic Standby (Draft) and Aerobic-to-Anaerobic-Transition Standby for a first vessel. This description should be read in conjunction with the SIS/BPCS integration flowchart of FIGS. 3(a) and 3(b). This flowchart sets out which actions occur in the SIS, which occur in the BPCS, and the signal exchanges required between the two systems.

With reference to the flowchart of FIG. 3, this example begins in the step “Wait for Phase Change Request”, seen specifically at FIG. 3(a).
1. Initial state is SIS Phase=“Aerobic Phase” (flag “V-1101 A” active) and BPCS Mode=“Aerobic Standby (Draft)”
2. Operator initiates a mode change to “Aerobic-to-Anaerobic-Transition Standby” mode via the BPCS Human Machine Interface (HMI)
3. If the SIS phase change permissive “V-1101 A to AN Tran Per” is healthy (defined as: all Vessel pressures are within operational parameters; the methane concentration within the Transition Line is low; the OMS is on-line and the current Phase for V-1101 is Aerobic), then the operator can initiate a phase change. If the BPCS sequence permissives are healthy, the BPCS prepares for a phase change by initialising the relevant BPCS valves
4. The BPCS sets the “V-1101 A to An Tran REQ” flag, indicating the BPCS is requesting a phase change from the SIS. This flag remains latched until the BPCS confirms successful completion of a phase change or 2 minute timeout
5. If the SIS phase change permissive “V-1101 A to AN Tran Per” is healthy, the SIS valves change to the positions defined in Table 2
6. If the “V-1101 A to An Tran REQ” flag is active AND all valves have successfully made their required positions, flag V-1101B is set and latched
7. Flag “V-1101 B” indicates the last known phase is now “Aerobic-to-Anaerobic-Transition Phase”
8. The BPCS sets the phase to Anaerobic-to-Aerobic-Transition Phase
9. The BPCS sets the BPCS valves to their new positions, as per FIG. 2
10. The BPCS sets the mode to “Aerobic to Anaerobic Transition Standby” and sends a confirmation signal, V-1101 B PCS to the SIS. This flag remains latched until the next phase change

The request for a phase change by the BPCS can be removed at anytime during the phase change sequence. Upon removal of the request the SIS and BPCS will return to their previous phase and standby mode, and align their respective valves accordingly.

If the SIS and BPCS valves fail to make their required positions within, for example, 60 seconds during a phase change, the SIS and BPCS return to their previous phase and standby mode. In this example, Aerobic Phase and Aerobic Standby (Draft), respectively.

If the SIS valve position feedbacks go into an unexpected state during normal operation or there is a phase/mode mismatch between SIS and BPCS, an alarm is raised.

Following a cold start of the SIS, the SIS controlled valves remain in the positions defined for a cold start condition until a valid phase is manually selected by the operator. The operator is required to set the current phase of the vessel in the SIS to match the actual physical state of the vessel. Manual selection of phase requires a two-step process as follows:
1. Placing the SIS phase initialisation keyswitch into the initialise position if the SIS instrument override is required; and
2. Initialising the phase from the HMI using the phase change request (for example “V-1101 A REQ”)

Phase change permissives are checked prior to allowing the phase to be initialised. However, as indicated in FIGS. 3(a) and 3(b), certain parts of each phase change permissive can be overridden by the operator while the vessel is in the cold start phase (SIS Phase Flag=“V-1101 E”).

Following a cold start of the BPCS, the BPCS initialises its valve positions and mode flag based on the phase flag in the SIS. If the SIS phase is unavailable (for example communications not healthy) or in the cold start phase (SIS Phase Flag=“V-1101 E”), the BPCS controlled valves remain in the failed positions until the SIS phase flag is set (i.e. SIS Phase Flag=“V-1101 A, B, C or D”).

A communications ‘watchdog’ is provided in the software layer for communications between the SIS and BPCS. It requires that a communications healthy flag in each system will become false if either or both of the following conditions are true for more than 30 seconds:
1. The link between the SIS and BPCS is down: or
2. The other system (BPCS or SIS) stops processing logic (for example CPU state=stop)

All signals exchanged between the systems are acted on only if the communications healthy flag is true.

If communications are lost, no further action is required. The last latched phase (“V-1101 A, B, C or D”) represents the safe state for the vessel.

Table 4 below sets out and summarises the signals exchanged between the two systems for the purposes of co-ordinating a mode/phase change. The signals are replicated for each vessel by replacing ‘x’ in the table with the vessel number.

All signals in the table below are logged in a BPCS event log.

TABLE 4

| Signal | Direction | Purpose |
|---|---|---|
| V-1x01 A | SIS->BPCS | Indicates SIS valves have moved to their correct |
| | | positions for Aerobic Phase (as confirmed by limit |
| | | switches) following a phase change request from the |
| | | BPCS. |
| | | This signal is latched in the SIS to indicate the last |
| | | confirmed phase. |
| V-1x01 B | SIS->BPCS | As above, for Aerobic-to-Anaerobic-Transition Phase |
| V-1x01 C | SIS->BPCS | As above, for Anaerobic Phase |
| V-1x01 D | SIS->BPCS | As above, for Anaerobic-to-Aerobic-Transition Phase |
| V-1x01 E | SIS->BPCS | Indicates SIS has been subjected to a power cycle |
| | | and is waiting for the operator to manually set the |
| | | current phase. |
| V-1x01 A PER | SIS->BPCS | Indicates SIS Permissive for changing to Aerobic |
| | | Phase is healthy |
| V-1x01 A to An Tran | SIS->BPCS | As above, for Aerobic-to-Anaerobic-Transition Phase |
| PER | | |
| V-1x01 An PER | SIS->BPCS | As above, for Anaerobic Phase |
| V-1x01 An to A Tran | SIS->BPCS | As above, for Anaerobic-to-Aerobic-Transition Phase |
| PER | | |
| V-1x01 A REQ | BPCS->SIS | Indicates the BPCS is requesting the SIS valves to |
| | | change to their required positions for Aerobic Phase. |
| | | This signal is latched in the BPCS until confirmation is |
| | | received that the SIS Phase Change Flag has been |
| | | set, or a timeout has occurred, whichever occurs first. |
| V-1x01 A to An Tran | BPCS->SIS | As above, for Aerobic-to-Anaerobic-Transition Phase |
| REQ | | |
| V-1x01 An REQ | BPCS->SIS | As above, for Anaerobic Phase |
| V-1x01 An to A Tran | BPCS->SIS | As above, for Anaerobic-to-Aerobic-Transition Phase |
| REQ | | |
| V-1x01 A PCS | BPCS->SIS | Indicates BPCS valves have moved to their correct |
| | | positions for Aerobic Standby (Draft) Mode (confirmed |
| | | by limit switches) following a mode change request |
| | | from the operator. This signal is latched in the BPCS |
| | | to indicate the last confirmed mode. |
| V-1x01 B PCS | BPCS->SIS | As above, for Aerobic-to-Anaerobic-Transition |
| | | Standby Mode |
| V-1x01 C PCS | BPCS->SIS | As above, for Anaerobic Standby Mode |
| V-1x01 D PCS | BPCS->SIS | As above, for Anaerobic-to-Aerobic-Transition |
| | | Standby Mode |

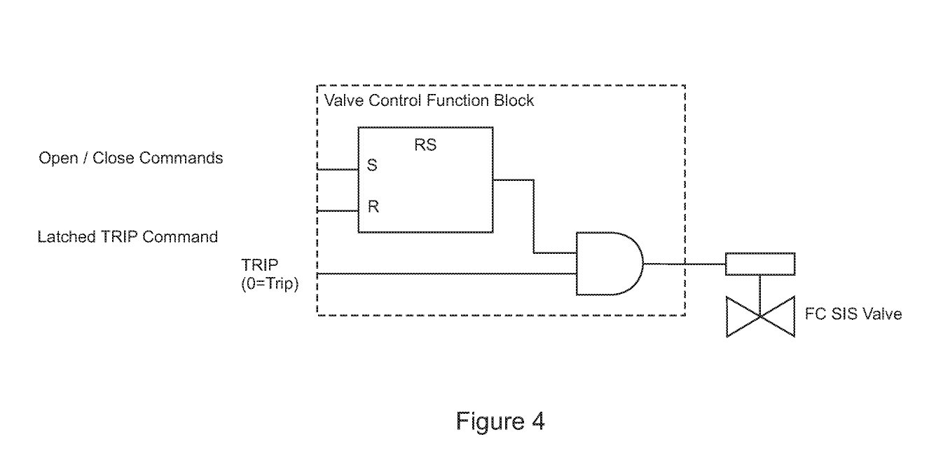

Each SIS controlled valve has an associated valve control function block, an example of which is shown in FIG. 4, to carry out the latching function required above.

Operation occurs as shown in FIG. 4 and Table 5 below, and provides certain functionality as set out immediately below:
(i) Once a valve position is requested, the valve control function block will latch this position and drive the valve accordingly;
(ii) A SIS trip will override the latched state and force the output to the tripped state for the duration of the SIS trip remaining active;
(iii) Once the SIS trip has cleared, the output of the function block will remain in the tripped state until the SIF has been reset at which time it will return to its previously latched state.

TABLE 5

COMMAND

| | OPEN | CLOSED |
|---|---|---|
| Set (S) | 1 | 0 |
| Reset (R) | 0 | 1 |

Control of Fail Last (FL) valves will be similar to that described above. However, the function block will be required to drive two solenoids as shown in Table 6 below. On a cold start, the outputs of both solenoids remain off until an Open/Close command is received.

TABLE 6

| Required Valve Position | Close Solenoid | Open Solenoid |
|---|---|---|
| Closed | On | Off |
| Open | Off | On |

As can be seen with reference to the above description, the present invention provides an operating method for a batch process, the batch process in one form being provided as a process for the treatment of the organic fraction of mixed municipal solid waste (“OFMSW”), that process including alternating phases of aerobic and anaerobic treatment conducted in a single reactor vessel.

Modifications and variations such as would be apparent to the skilled addressee are considered to fall within the scope of the present invention.

1. An operating method for a batch process, the batch process comprising a plurality of operating phases and within each phase there is provided at least one operating mode, one of the modes of each phase being a standby mode or its equivalent, wherein a transition from a first phase to a second phase requires that the first phase be initialised to its standby mode or equivalent and upon completion of the phase change the second phase enters its standby mode or equivalent, the operating phases further comprising alternating phases of aerobic and anaerobic treatment conducted in a single reactor.

2. An operating method according to claim 1, wherein valve and drive configurations of the standby modes or their equivalent in phases between which a transition occurs are substantially similar, thereby allowing efficient progression from one phase to another.

3. An operating method according to claim 1, wherein the equivalent of the or each standby mode is a target configuration of valves and drives embedded within a distinct mode or within a sequence of modes or phases involved in a change from the first stage to the second stage.

4. An operating method according to claim 1, wherein the batch process is directed to the treatment of the organic fraction of mixed municipal solid waste.

5. An operating method according to claim 1, wherein the batch process is directed to the treatment of the organic fraction of mixed municipal solid waste, the plurality of operating phases comprising the following phases:
a. Aerobic;
b. Anaerobic; and
c. Transition.

6. An operating method according to claim 5, wherein the Transition operating phase in turn comprises one of an Aerobic-to-Anaerobic-Transition phase, to remove oxygen from a headspace of the reactor vessel, or an Anaerobic-to-Aerobic-Transition phase, to remove methane from, and introduce oxygen into, the headspace of the reactor vessel while avoiding the formation of a flammable gas mixture.

7. An operating method according to claim 5, wherein the Aerobic phase comprises one or more of the following modes of operation:
(i) Standby;
(ii) Loading (draft);
(iii) Loading & recirculate solids (draft);
(iv) Recirculate solids (draft);
(v) Unloading (draft);
(vi) Recirculate solids (pressure vent); and
(vii) Pressure vent.

8. An operating method according to claim 6, wherein the Aerobic-to-Anaerobic-Transition phase comprises the following modes of operation:
(i) Standby; and
(ii) Transition.

9. An operating method according to claim 6, wherein the Anaerobic phase comprises the following modes of operation:
(i) Standby;
(ii) Fill & recirculate liquid;
(iii) Empty liquid; and
(iv) Recirculate solids.

10. An operating method according to claim 6, wherein the Anaerobic-to-Aerobic-Transition phase comprises the following modes of operation:
(i) Standby;
(ii) Pressure vent; and
(iii) Purge.

11. An operating method according to claim 10, wherein the purge of step (iii) of the Anaerobic-to-Aerobic Transition phase is a purge to an odour management system.

12. An operating method according to claim 6, wherein the Anaerobic-o-Aerobic-Transition phase comprises the following modes of operation:
(i) Standby;
(ii) Continuous purge of an inert or exhaust gas; and
(iii) Purge.

13. An operating method according to claim 1, wherein there is further provided a safety instrumented system (SIS).

14. An operating method according to claim 13, wherein there is further provided a basic process control system (BPCS) that operates in accordance with, and is governed by, the safety instrumented system.

15. An operating method according to claim 14, wherein the SIS makes decisions regarding the granting of permission when it is requested by the BPCS based on a number of parameters at that time, including one or more of valve positions/settings, pressure, gas composition and flow rates.

16. An operating method according to claim 15, wherein the BPCS is set at a ‘lower’ or ‘earlier’ level thereby substantially avoiding circumstances in which the SIS needs to intervene and halt the process, and which would cause a failsafe state.

17. An operating method according to claim 14, wherein to initialise a change of phase the following steps are undertaken:
(i) The mode for a current phase is set to a phase specific standby mode;
(ii) The SIS confirms that it is safe to make the change of phase;
(iii) The BPCS moves specific BPCS controlled valves to appropriate positions in preparation for the change of phase;
(iv) The BPCS requests the SIS to make the change of phase;
(v) The SIS moves SIS controlled valves to the appropriate valve states;
(vi) The SIS sets its phase to the new phase;
(vii) The SIS informs the BPCS of the new phase and monitors the BPCS movement to the new phase;
(viii) The BPCS sets the phase to the new phase;
(ix) The BPCS moves BPCS controlled valves into position to facilitate the change of phase to appropriate phase specific standby state; and
(x) The BPCS mode is set to standby and provides confirmation to the SIS.

18. An operating method according to claim 17, wherein the BPCS and SIS perform a ‘handshake’ at steps (ii) and (iv), whereby the BPCS requests the permission of the SIS to make the phase change.

19. An operating method according to claim 17, wherein with regard to step (vii), if the BPCS is not set to the new phase within a specific time frame from the commencement of step (iii), the SIS reverts to the previous phase and will raise a phase change failure alarm.

20. An operating method according to claim 19, wherein the specific time frame is a period of about 2 minutes.

21. An operating method according to claim 6, wherein only the following phase changes are possible:
(i) Aerobic phase to Aerobic-to-Anaerobic Transition phase;
(ii) Aerobic-to-Anaerobic-Transition phase can change, depending upon process conditions, to either of Aerobic phase or Anaerobic phase;
(iii) Anaerobic phase to Anaerobic-to-Aerobic-Transition phase; and
(iv) Anaerobic-to-Aerobic-Transition phase can change, depending upon process conditions, to either of Aerobic phase or Anaerobic phase.
